(19) United States
(12) Patent Application Publication
(10) Pub. No.: US 2013/0213874 A1
(43) Pub. Date: Aug. 22, 2013

(54) Water filter pouch for use in a drinking water pitcher

(71) Applicant: Silas Robert Boskov, Port Moody (CA)

(72) Inventor: Silas Robert Boskov, Port Moody (CA)

(21) Appl. No.: 13/767,010

(22) Filed: Feb. 14, 2013

Related U.S. Application Data
(60) Provisional application No. 61/600,679, filed on Feb. 19, 2012.

(51) Int. Cl. C02F 1/28

(52) U.S. Cl. CPC C02F 1/281
USPC 210/263

(57) ABSTRACT

The present invention provides a water filter pouch for use in a drinking water pitcher. The complete water filter pouch having specialized construction enabling it to be disposed of in composting facilities. The water filter pouch is comprised of a closed water permeable pouch containing a filter media comprising activated carbon and zeolite in a ratio from 100:0 to 30:70. The water filter pouch may include one or more bands of water impermeable material to ensure water does not bypass the filter media contained within the water filter pouch.

### CROSS-REFERENCE TO RELATED APPLICATIONS

This application claims the benefit of Provisional Patent Application Ser. No. 61/600,679 filed Feb. 19, 2012 by the present inventor.

### FEDERALLY SPONSORED RESEARCH

Not Applicable

### SEQUENCE LISTING OR PROGRAM

Not Applicable

### FIELD OF THE INVENTION

The present invention relates to water filters for use in drinking water pitchers. More specifically, the present invention provides a water filter having specialized construction enabling it to be disposed of in composting facilities.

### BACKGROUND OF THE INVENTION

Water pitchers that include a filtering device are now a common kitchen item. Many of these water pitchers have a replaceable water filter cartridge as the filtering device: the water pitcher having an upper and lower reservoir with a water filter cartridge located between the reservoirs, employing gravity to draw water through the water filter cartridge as the water passes from the upper to the lower reservoir. An example of such a cartridge is U.S. Pat. No. D579515 to Bell.

The water filter cartridges used in these water pitchers typically have a two to three month service life.

These water filter cartridges are not easily reused, recycled or disposed of in an environmentally sound manner. At the end of their service life the vast majority of water filter cartridges end up as household garbage: going into the landfill or being incinerated.

Although at least one manufacturer of water filter cartridges has offered a disposal service whereby used water filter cartridges can be returned to the manufacturer to be reprocessed, this is inconvenient and the effort itself consumes additional resources.

Consumers are now more aware than ever that their purchasing decisions have an impact on the environment. This has created a demand for products with less environmental impact, specifically products that can be recycled or disposed of in composting facilities. Many municipalities and similar bodies responsible for the disposal of consumer waste have encouraged this shift in consumption and many have split the waste stream, offering consumers the opportunity to divert compost acceptable and recyclable materials to suitable destinations.

A typical water filter cartridge has many elements which impede its disposal through recycling or composting facilities:

The plastic shell of a typical water filter cartridge is not biodegradable. The plastic shell is often not identified by a plastic identification code number thereby failing to aid recycling. The plastic shell is not easily separated from its contents further impeding recycling. This all contributes to water filter cartridges being disposed of in landfills or incinerators.

The filter media inside a typical water filter cartridge contains activated carbon that has been impregnated with silver. This treatment with silver, intended to inhibit bacteria growth, makes the contents unsuitable for disposal in composting facilities. Typical water filter media also includes ion exchange resin, usually in pellet form, which is also not suitable for disposal in composting facilities. This all contributes to water filter cartridges being disposed of in landfills or incinerators.

### SUMMARY

The present invention provides a water filter pouch for use in a drinking water pitcher. The water filter pouch is comprised of a dosed water permeable pouch containing a filter media comprising activated carbon and zeolite in a ratio from 100:0 to 30:70. A preferred embodiment includes one or more bands of water impermeable material to ensure water does not bypass the filter media contained within the water filter pouch. The complete water filter pouch has specialized construction enabling it to be disposed of in composting facilities.

### DRAWINGS

FIG. 1 Water filter pouch with three side seal

FIG. 2 Water filter pouch cross sectional view

FIG. 3 Water pitcher with water filter pouch exploded view

FIG. 4 Water pitcher with water filter pouch cross sectional view

FIG. 5 Water filter pouch with central seal construction

FIG. 6 Water filter pouch with four side seal construction

FIG. 7 Water filter pouch with pyramid pouch construction

FIG. 7A Water filter pouch with pyramid pouch construction side view

FIG. 8 Water filter pouch with gusseted pouch construction

FIG. 9 Water filter pouch with flat bottom construction

FIG. 10 Water filter pouch with stand up construction

FIG. 11 Water filter pouch having a belt of water impermeable material

FIG. 12 Water filter pouch having multiple belts of water impermeable material

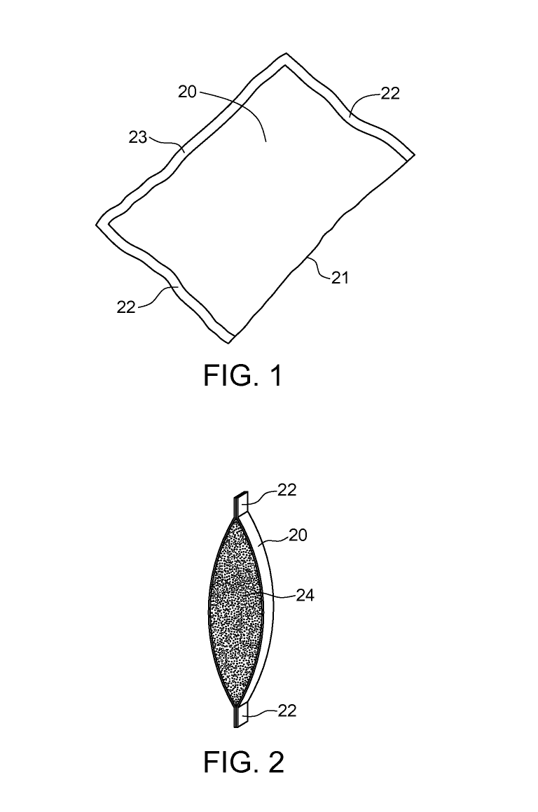

### DETAILED DESCRIPTION—FIGS. 1-4—PREFERRED EMBODIMENT

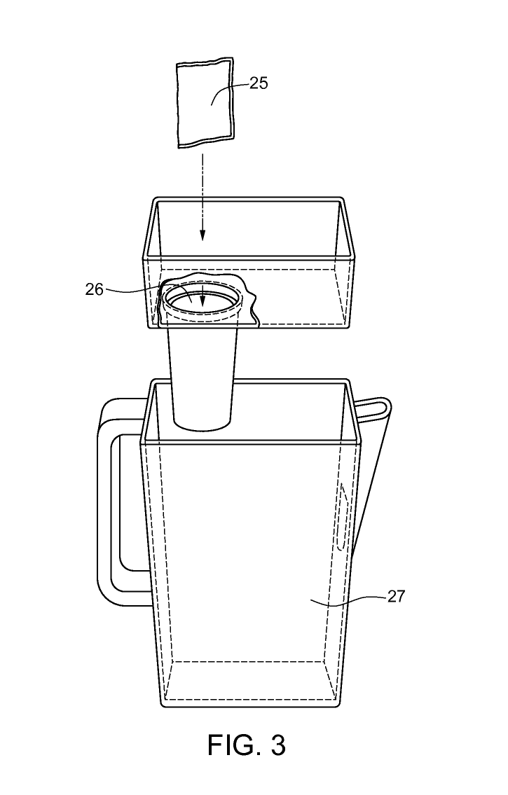

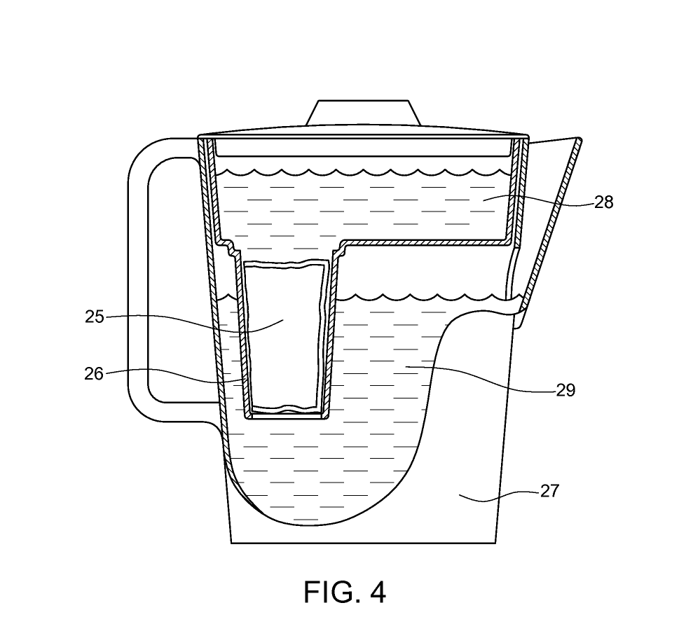

A preferred embodiment of the water filter pouch of the present invention is illustrated in FIG. 1 (front view) and FIG. 2 (side cross-sectional view). The water filter pouch is intended to form a part of a water pitcher, one example of such a water pitcher is illustrated in FIG. 3 (exploded view) and FIG. 4 (cross sectional view).

A preferred embodiment of the water filter pouch illustrated in FIG. 1 has a thin pouch 20 which consists of a pliable water permeable material folded 21 over onto itself and sealed with three seals: a seal 22 on each end and a seal 23 aligned approximately transversal relative to the end seals, to form a closed pouch. This configuration of pouch is known as a three side seal.

The water filter pouch has a pouch 20 constructed of material that is both biodegradable yet is also able to withstand being immersed in water for extended periods of time without rapidly degrading. A preferred embodiment of the water filter pouch has a pouch constructed of material which does not readily degrade from being immersed in water for a duration of at least two months yet still biodegrades in composting facilities. An example of this type of material is Bioweb by Ahlstrom, USA. A preferred embodiment of the water pouch has a pouch constructed of material biodegradable and compostable to European standard EN13432.

For ease of assembly, the pouch 20 of the water filter pouch is constructed from a material that can be ultrasonically welded, heat welded, or both. A preferred embodiment has the pouch constructed of biodegradable nonwoven or mesh material. A preferred embodiment of the water filter pouch as a pouch constructed of biodegradable polylactic acid plastic.

A preferred embodiment has the pouch of the water filter pouch constructed of nonwoven material with a weight from 17 grams per square meter to 170 grams per square meter. A preferred embodiment of the water filter pouch has a pouch constructed of mesh with a weight from 35 grams per square meter to 217 grams per square meter.

FIG. 2 illustrates a preferred embodiment of the water filter pouch, having contained inside the pouch a filter media 24 consisting of activated carbon and zeolite in a ratio ranging by volume from 100:0 to 30:70. The filter media may be in granular form, pellet form, or a mixture of both. The water filter media is void of silver treated activated carbon and void of on exchange resin.

The filter media 24 contained within the water filter pouch is suitable for disposal in composting facilities. A preferred embodiment of the water filter pouch has the filter media having an absence of negative effects on the composting process as checked with a composting test OECD 208 modification annex E.

In FIG. 3 a preferred embodiment of the water filter pouch 25 is illustrated along with an exploded view of a typical water pitcher 27 having a cavity 26 for insertion of a water filter pouch.

In FIG. 4 a preferred embodiment of the water filter pouch 25 is illustrated along with a cross sectional view of a typical water pitcher 27 having a cavity 26 for insertion of a water filter pouch. The water pitcher 27 having an upper reservoir 28 to hold water that has yet to pass through the water filter pouch and a lower reservoir 29 for water that has passed through the water filter pouch.

### Alternative Embodiments

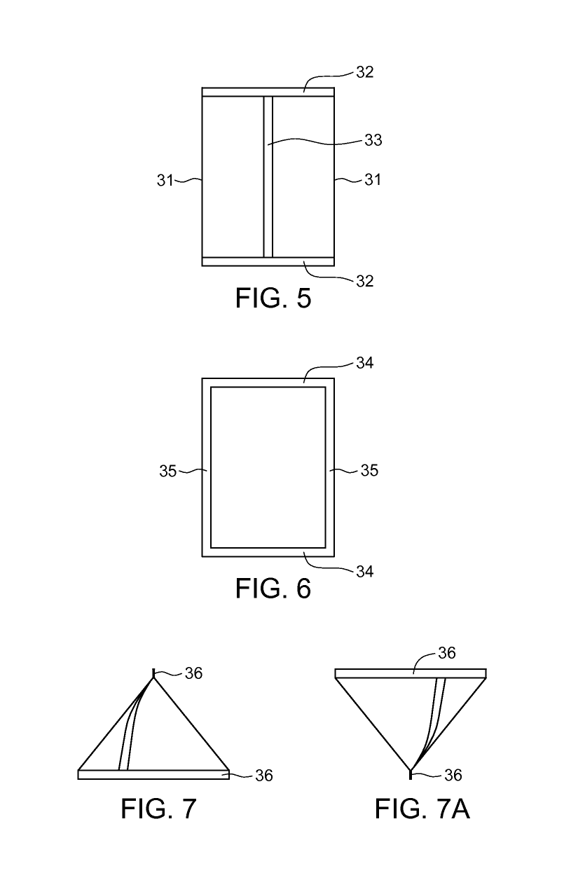

Although a pouch of three side seal configuration is illustrated in FIG. 1 through FIG. 4, the water filter pouch may have a pouch in other pouch configurations including those illustrated in FIGS. 5 to 12.

### FIGS. 5 To 12

Alternative embodiments are shown in FIGS. 5, 6, 7, 7A, 8, 9, 10, 11, and 12;

FIG. 5 shows a preferred embodiment of a water filter pouch having a pouch which consists of a pliable sheet of water permeable material folded over itself with two folds 31, sealed with three seals, a seal 32 on each end and a seal 33 aligned transversally relative to the end seals, to form an enclosed pouch. This configuration of pouch is known as a central seal pouch.

FIG. 6 shows a preferred embodiment of a water filter pouch having a pouch which consists of two layers of pliable water permeable material, sealed with four seals, a seal 34 on each end and two seals 35 aligned transversally relative to the end seals, to form an enclosed pouch. This configuration of pouch is known as a four side seal pouch.

FIG. 7 front view and FIG. 7A side view show a preferred embodiment of a water filter pouch having a pouch constructed similarly to those shown in FIG. 1, FIG. 5 and FIG. 6, however the end seals 36 are at different angles of rotation relative to each other around the vertical axis. In the illustrations of FIG. 7 and FIG. 7A the end seals 36 are shown aligned at a 90 degree angle relative to each other as rotated around the vertical axis but can be positioned at other angles. This configuration of pouch is known as a pyramid pouch.

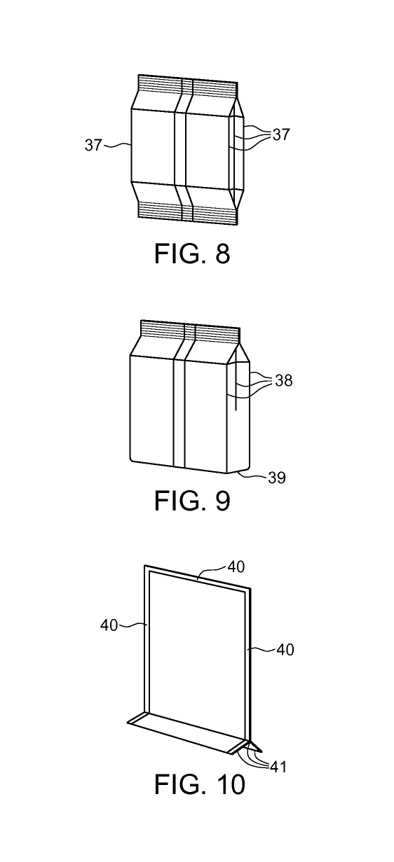

FIG. 8 shows a preferred embodiment of a water filter pouch having a pouch constructed similarly to that shown in FIG. 5, but with the addition of three folds 37 on each side to create a gusset on each side of the pouch, This configuration of pouch is known as a gusseted pouch.

FIG. 9 shows a preferred embodiment of a water filter pouch having a pouch constructed similarly to that shown in FIG. 8, with three folds 38 on each side to create a gusseted pouch, with additional folds and seals to form a flat bottom 29. This configuration of pouch is known as a flat bottom pouch.

FIG. 10 shows a preferred embodiment of a water filter pouch having a pouch constructed similarly to that shown in FIG. 1 which has three seals 40, but with three folds 41 at one end to create a stand up pouch. This configuration of pouch is known as a stand up pouch.

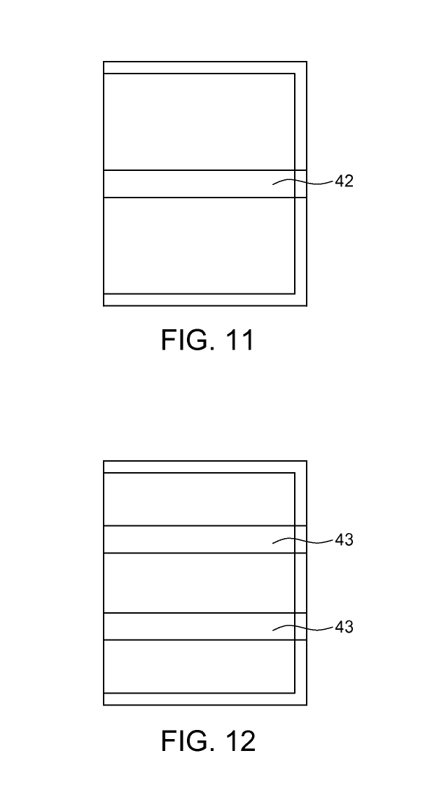

FIG. 11 shows a preferred embodiment of a water filter pouch having a belt 42 of water impermeable material running around the circumference of the water filter pouch. The belt is an incorporated part of the pouch, rather than an additional external layer of the pouch. The belt may be located at any point along the length of the pouch, the height of the belt, measured perpendicular to the circumference of the belt, may be as long as the majority of the length of the pouch. A preferred embodiment of the water filter pouch has a belt 32 of solid pliable material. However, the belt material may be other water impermeable material including hydrophobic nonwoven or mesh material. The illustration of FIG. 11 is of a three side seal pouch however a belt is equally suitable on any other pouch configuration including those illustrated in FIGS. 5 to 10.

FIG. 12 shows a preferred embodiment of a water filter pouch having a multitude of belts 43 of non-water permeable material running around the circumference of the water filter pouch. The belts are an incorporated part of the pouch, not an additional external layer of the pouch. The belts may be located at any point along the length of the pouch, the height of the belts, measured perpendicular to the circumference of the belts, may be as long as the majority of the length of the pouch. A preferred embodiment of the water filter pouch has belts 43 of solid pliable material. However, the belts material may be other water impermeable material including hydrophobic nonwoven or mesh material. The illustration of FIG. 11 is of a three side seal pouch however belts are equally suitable on any other pouch configuration including those illustrated in FIGS. 5 to 10. Belts do not necessarily have to be parallel to one another.

### Operation FIGS. 3, 4

A preferred method of use is described as follows:

Before the water filter pouch can be used in a water pitcher it is put through an initial soak and rinse. Using cold potable municipal drinking water, the water filter pouch is initially immersed in water to soak for 15 minutes then rinsed for 30 seconds. The water filter pouch 25 is then press fit into the cavity 26 in a water pitcher 27.

Cold potable municipal drinking water is poured into the upper reservoir 28 of the water pitcher. Gravity draws the water from the upper reservoir 28 into the water permeable pouch of the water filter pouch 25, through the filter media contained inside the pouch, and out of the pouch where it collects in the lower reservoir 29 of the water pitcher.

As the water is passing through the water filter pouch the water interacts with the filter media. Activated carbon in the filter media improves the drinking water by reducing the level of various contaminants which might be found in the water including lead, chlorine, certain organic compounds, and many compounds that affect taste and odor. In a preferred embodiment of the water filter pouch that includes zeolite as part of the filter media, the zeolite operates as a water softener through a process called ion exchange.

The water filter pouch remains in the water filter pitcher during its service life. The water filter pouch and water pitcher are primarily kept refrigerated during the water filter pouch service life.

After a recommended service life typically of about two to three months, the water filter pouch is removed from the water pitcher and the complete water filter pouch is placed into disposal in municipal or commercial composting facilities or any similar composting facilities providing the basic conditions for the breakdown of the pouch material of the water filter pouch.

In the composting facility, the pouch material of the water filter pouch biodegrades into compost acceptable material. The contents of the water filter pouch, primarily activated carbon, does not readily decompose but is already in a form acceptable to composting facilities: activated carbon of this form being used in soil remediation. Similarly, for a preferred embodiment where the filter media includes zeolite, the zeolite does not readily decompose but is already in a form acceptable to composting facilities: zeolite of this form being used as a composting aid and for soil remediation.

### Operation of Belts FIG. 1, 4, 11, 12

As previously described, the water filter pouch 25 is press fit into a cavity 26 in the water pitcher. Water is placed in an upper reservoir 28 in the water pitcher and drawn by gravity down through the water filter pouch 25 and into a lower reservoir 29.

The design of the water filter pouch is intended to allow water to enter the water permeable pouch 20, come into contact and interact with the filter media 24 contained inside the pouch, and then exit the pouch through the water permeable material. However, it is possible in some situations that the water to be filtered may bypass the filter media by travelling the length of the water filter pouch primarily through the water permeable material of the pouch itself, without coming into contact with the filter media, thereby defeating the function of the water filter pouch. Reasons for this happening include: when the pouch material of a water filter pouch offers less resistance to water flow than the filter media contained inside the pouch or when the water filter pouch has not been pressed into the cavity in the water pitcher with the required force or technique to sufficiently compress the pouch material between the filter media and cavity walls 26 to increase resistance to water flow.

A belt 42 or belts 43 of water impermeable material, aligned relatively perpendicular to the intended flow of water through the water filter pouch, will block water from flowing exclusively through the pouch of the water filter pouch and instead force the water to exit the pouch material and come into contact with the filter media contained inside the water filter pouch.

The operation instructions are given as an example and are not intended to limit the scope of this patent.

### Advantages

From the description above, a number of advantages to the water filter pouch become evident:

By taking advantage of advancements in biodegradable materials, the pouch portion of the water filter pouch is able to withstand being wet or immersed in water for two or more months while positioned in the water filter pitcher yet is also biodegradable, allowing the water filter pouch to be disposed of in composting facilities.

Additionally, two key improvements in the filter media enable the contents of the water filter pouch to be suitable for disposal in composting facilities: replacing silver treated activated carbon with activated carbon void of silver treatment and replacing ion exchange resin with zeolite.

These combined improvements allow the complete water filter to be disposed of in composting facilities, while still offering suitable water filtration and water softening.

The water filter pouch also requires less plastic to manufacture. A water filter pouch of nonwoven plastic can be constructed using 80% less plastic by weight compared to a typical water filter cartridge.

### Conclusions

Through the following confluence of changes and developments there is now a demand for, an ability to produce, and properly use a water filter pouch that is acceptable for disposal in composting facilities:
increased concern for the environment
increase in consumer demand for recyclable and composting facility acceptable products
increased availability of municipal and commercial composting in urban areas
the development of new grades of biodegradable materials, including those that can withstand two or more months of exposure to water immersion or wet environments without readily degrading, yet still biodegrade in municipal and commercial composting facilities, properties that did not exist prior to their recent development

The present invention provides a water filter pouch that is uniquely designed to be manufactured and consumed with reduced environmental impact. The water filter pouch requires significantly less plastic to manufacture. The water filter pouch is able to be disposed of in composting facilities. Yet the complete water filter pouch improves water comparably to that of a water filter cartridge.

Note that though a gravity fed water pitcher has been used in illustrating the water filter pouch of the present invention, it is to be understood that any type of water pitcher, carafe, bottle or other gravity drawn filtration device could be used in combination with this invention. This invention should not be construed as being limited in scope exclusively to filtering water in gravity fed water pitchers.

Note that ‘water impermeable’ is used to describe the band or bands of material that prevent water flow. This description is intended to include hydrophobic material that resists the flow of water.

1. A water filter for use in a drinking water pitcher, comprising:
(a) a filter media
(b) said filter media comprising a mix of activated carbon and zeolite from a ratio by volume ranging from 100:0 to 30:70
(c) said filter media is in a form selected from the group consisting of granular and pellet and any combinations thereof
(d) said filter media void of silver treated activated carbon
(e) said filter media void of on exchange resin
(f) a closed pouch
(g) said pouch being constructed of a water permeable, biodegradable material
(h) said filter media housed within said pouch
(i) said pouch constructed of material selected from the group consisting of nonwoven material and mesh material and any combinations thereof whereby said water filter is suitable for disposal in composting facilities.

2. The water filter of claim 1 wherein said pouch constructed of material which does not readily degrade from being immersed in water for a duration of at least two months.

3. The water filter of claim 2 wherein said filter media has an absence of negative effects on the composting process as tested with a composting test OECD 208 modification annex E.

4. water filter of claim 3 wherein said pouch constructed of material biodegradable and compostable to European standard EN13432.

5. The water filter of claim 4 wherein said pouch constructed in a pattern selected from the group consisting of three side seal, central seal, four side seal, pyramid, gusseted, flat bottom, and stand up.

6. The water filter of claim 5 wherein said pouch constructed of polylactic add plastic.

7. The water filter of claim 4 wherein said pouch includes one or more belts of water impermeable material whereby preventing the water from bypassing the filter media

8. The water filter of claim 2 wherein said pouch includes one or more belts of water impermeable material whereby preventing the water from bypassing the filter media

9. The water filter of claim 8 wherein said pouch constructed of polylactic acid plastic.

10. A water filter for use in a drinking water pitcher, comprising:
(a) a filter media
(b) said filter media comprising a mix of activated carbon and zeolite from a ratio by volume ranging from 100:0 to 30:70
(c) said filter media is in a form selected from the group consisting of granular and pellet and any combinations thereof
(d) a closed pouch
(e) said pouch being constructed of a water permeable, biodegradable material
(f) said filter media housed within said pouch
(g) said pouch constructed of material selected from the group consisting of nonwoven material and mesh material and any combinations thereof.

11. The water filter of claim 10 wherein said pouch constructed of material which does not significantly degrade from being immersed in water for a duration of at least two months.

12. The water filter of claim 11 wherein said filter media has an absence of negative effects on the composting process as checked with a composting test OECD 208 modification annex E.

13. The water filter of claim 12 wherein said pouch constructed of material biodegradable and compostable to European standard EN13432.

14. The water filter of claim 13 wherein said pouch constructed in a pattern selected from the group consisting of three side seal, central seal, four side seal, pyramid, gusseted, flat bottom, and stand up.

15. The water filter of claim 14 wherein said pouch constructed of polylactic acid plastic.

16. water filter of claim 13 wherein said pouch includes one or more belts of water impermeable material whereby preventing the water from bypassing the filter media

17. The water filter of claim 11 wherein said pouch includes one or more belts of water impermeable material whereby preventing the water from bypassing the filter media

18. The water filter of claim 17 wherein said pouch constructed of polylactic acid plastic.

19. A water filter for use in a drinking water pitcher, comprising:
(a) a filter media
(b) said filter media comprising a mix of activated carbon and zeolite from a ratio by volume ranging from 100:0 to 30:70
(c) said filter media is in a form selected from the group consisting of granular and pellet and any combinations thereof
(d) a closed pouch
(e) said pouch being constructed of a water permeable, biodegradable plastic
(f) said filter media housed within said pouch
(i) said pouch constructed of material which does not significantly degrade when immersed in water for a duration of at least two months.

20. The water filter of claim 19 wherein said filter media has an absence of negative effects on the composting process as checked with a composting test OECD 208 modification annex E.

21. The water filter of claim 20 wherein said pouch includes one or more belts of water impermeable material whereby preventing the water from bypassing the filter media
